(19) United States
(12) Patent Application Publication
(10) Pub. No.: US 2012/0046777 A1
(43) Pub. Date: Feb. 23, 2012

(54) Integrated machining and part inspection method

(76) Inventors: Jamie L. Imhoff, Houston, TX (US); Leopoldo S. Gomez, Humble, TX (US); Kris Church, Montgomery, TX (US)

(21) Appl. No.: 12/859,485

(22) Filed: Aug. 19, 2010

(51) Int. Cl. G05B 19/401

(52) U.S. Cl. 700/110

(57) ABSTRACT

A CNC machining method that incorporates a dimensional probe that allows inspection after stages of machining to determine actual dimensions with respect to the target dimension allows for corrective measures before advancing to the next step of the process so as to reduce the number of rejects at the end of the machining process. In making a tubular thread that involves initially machining a taper followed by the thread form, the probe and the various cutters are oriented against gauge blocks supported in the chuck jaws. The probe is used to dimensionally inspect the taper that is cut as an initial step before the thread form is produced. Inspection using the probe takes place upon machining the taper and after the thread form is cut using the probe integrated into the machine.

### FIELD OF THE INVENTION

The field of the invention is a CNC machining method and more particularly involving step machining with integration of inspection function into the process as the piece is being formed for enhanced dimensional measurement against specifications.

### BACKGROUND OF THE INVENTION

Numerically controlled machining has been in use for a long time and is used to produce a variety of shapes including tubular threads. While there are a variety of techniques used to machine the given part, inspection of the part has involved manual techniques such as using hard gauges that themselves have to be machined to exact dimensions and have to be fit over or into the part that is being checked in a manual operation. In some cases the part has to be removed from the machine to be inspected, which can be a source of inaccuracies when the part is remounted for further machining.

What is not done and is offered by the method of the present invention is a way to integrate the inspection with the fabrication of the component. The CNC machine integrates an inspection probe that is initially calibrated using gauge blocks attached to the chuck jaws. With the probe calibrated, the coarse and fine cutters can be calibrated against the piece to be cut when it is in the chuck. In the case of a thread being cut the coarse and fine thread cutters are also calibrated against the piece to be cut. The piece can have a coarse and fine tapered cut that is then inspected by the probe before a thread is cut in two stages and then inspected. A similar procedure can be used to make the pin and box of a tubular thread.

The integration of the probe for dimensional inspection of the piece during the stages of machining it reduces rejects and allows the possibility of corrective machining before another step is undertaken should the out of tolerance indication still be fixable with further machining. Those skilled in the art will be able to further understand the details of the present invention from the description of the preferred embodiment and the associated drawings while understanding that the full scope of the invention is to be determined by the appended claims.

### SUMMARY OF THE INVENTION

A CNC machining method that incorporates a dimensional probe that allows inspection after stages of machining to determine actual dimensions with respect to the target dimension allows for corrective measures before advancing to the next step of the process so as to reduce the number of rejects at the end of the machining process. In making a tubular thread that involves initially machining a taper followed by the thread form, the probe and the various cutters are oriented against gauge blocks supported in the chuck jaws. The probe is used to dimensionally inspect the taper that is cut as an initial step before the thread form is produced. Inspection using the probe takes place upon machining the taper and after the thread form is cut using the probe integrated into the machine.

### BRIEF DESCRIPTION OF THE DRAWINGS

FIG. 1 shows a probe calibration step using gauge blocks in a chuck jaw;

FIG. 2 is a schematic representation of the support for the probe as a part of a CNC machine;

FIG. 3 shows the tubular in the jaw with the probe used to determine its initial location;

FIG. 4 shows locating the coarse ramp cutter to the piece using perpendicular orientation axes;

FIG. 5 shows the fine ramp cutter oriented to the piece using perpendicular orientation axes;

FIG. 6 shows the orientation of the coarse pin thread cutter using perpendicular orientation axes;

FIG. 7 shows the orientation of the finish or Higbee cutter using perpendicular orientation axes;

FIG. 8 shows the rough ramp cut;

FIG. 9 shows the fine ramp cut after the rough cut;

FIG. 10 shows an inspection of the ramp length and nose configuration of the pin;

FIG. 11 shows a second check of the ramp and details at opposed ends;

FIG. 12 shows the coarse cut for the pin threads;

FIG. 13 shows a detailed inspection of the probe of the thread form just cut;

FIG. 14 shows the fine cut for the thread form;

FIG. 15 shows the inspection of the thread form after the fine cut; and

FIG. 16 shows some finish machining on the pin nose after the previous inspection of FIG. 15.

### DETAILED DESCRIPTION OF THE PREFERRED EMBODIMENT

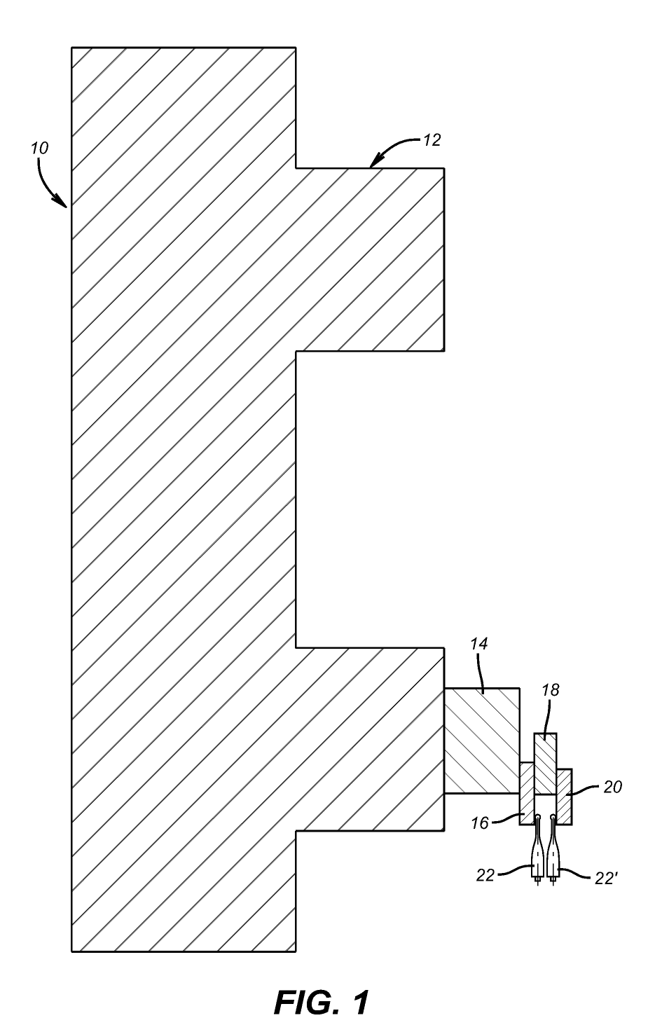

FIG. 1 illustrates a schematic chuck 10 with an extending jaw assembly 12 with an assembly of gage blocks 14, 16, 18 and 20. The block 16 allows for a reference diameter location for the probe tip 22. The probe 22 can move laterally between its position to the 22′ position for calibration of a dimension using a known lateral spacing between blocks 16 and 20 with such gap being the thickness of the block 18.

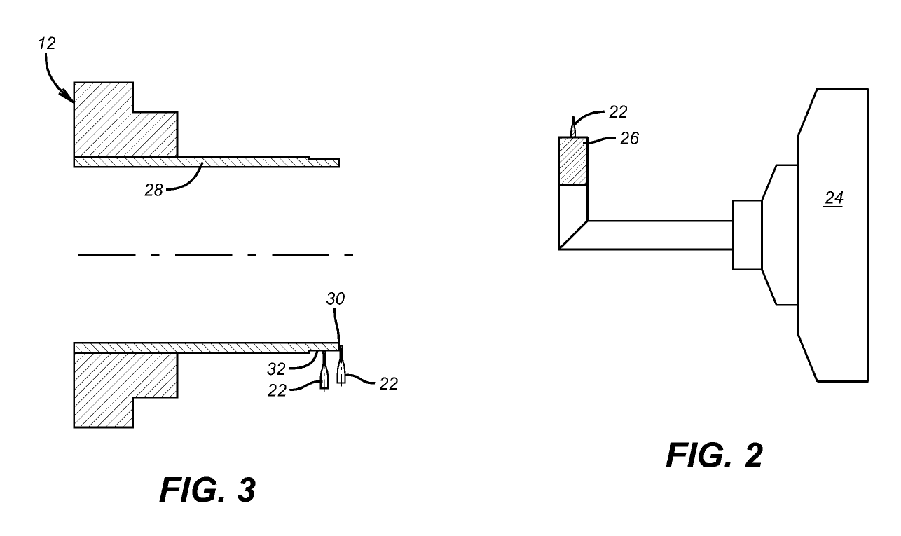

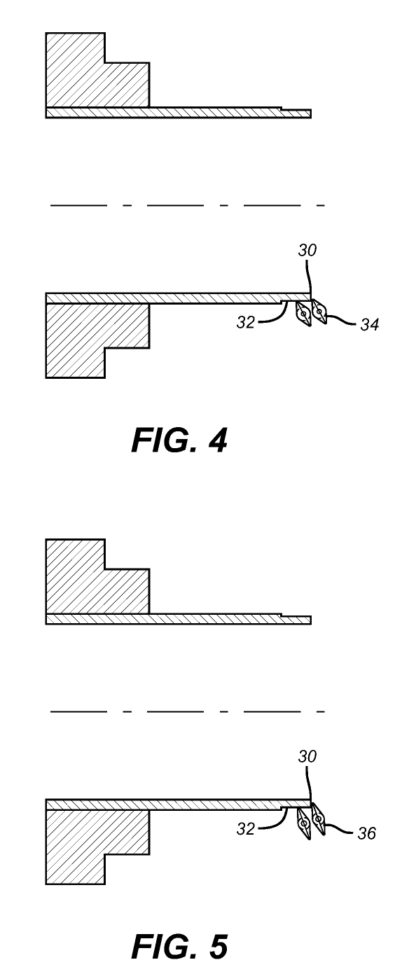

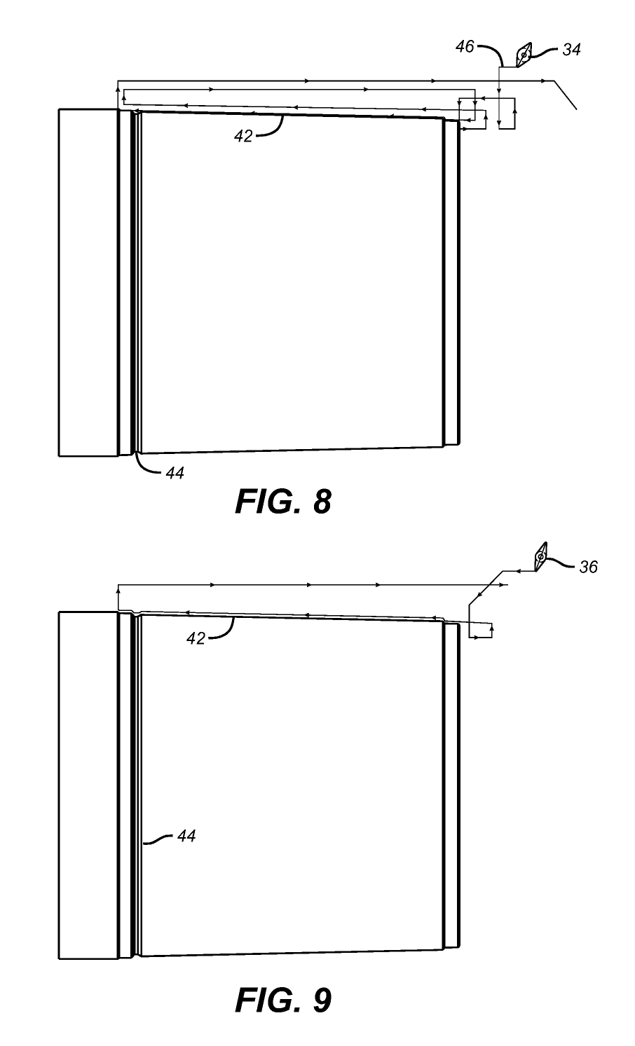

FIG. 2 shows an articulated frame 24 that is controlled by a processor in the CNC machine, all shown in a schematic representation, to direct the movements of the probe 22 located at its end 26. FIG. 3 shows the tubular 28 in the jaw assembly 12 with probe 22 positioned at end 30 for locating purposes and then positioned in recess 32 to determine its diameter. Having done that, the coarse cutter 34 is positioned in FIG. 4 at end 30 and recess 32 to set up its initial position for cutting based on the results from using the probe 22 in the step shown in FIG. 3. That step is followed by positioning the fine cutter 36 at the locations 30 and 32 as shown in FIG. 5. The coarse and fine cutters 34 and 36 will ultimately be used to form a taper on the piece 28 before the thread form is machined. This is shown in FIGS. 8 and 9.

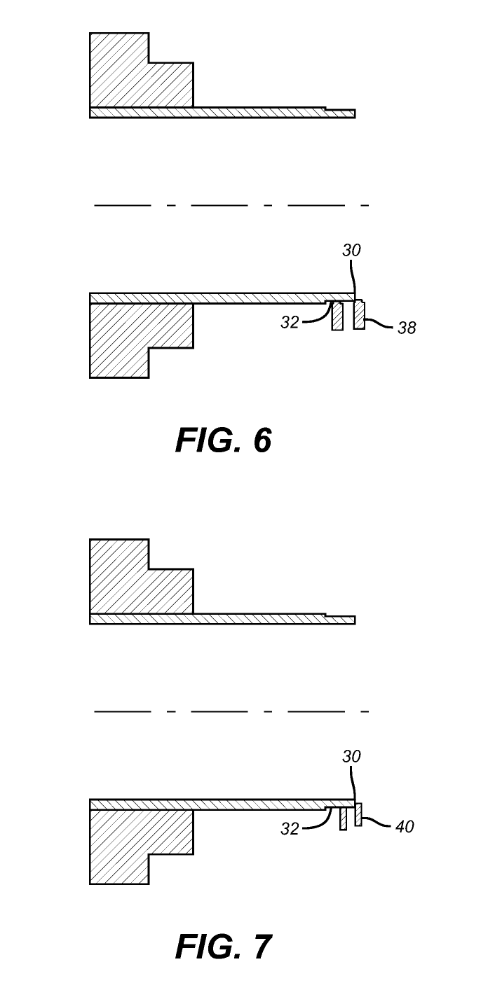

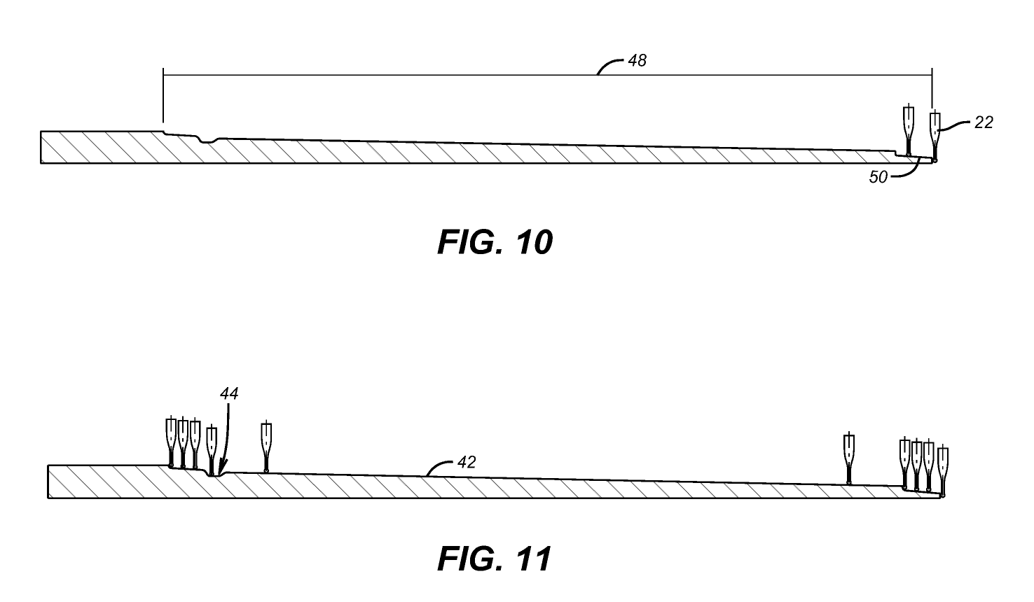

FIG. 6 shows the positioning of the coarse thread cutter 38 at the locations 30 and 32 while FIG. 7 shows the finish thread cutter 40 at the same locations. At this point, the piece to be cut 28 is properly located with respect to each of the cutters and the cutting process to make a pin connection can begin. As shown in FIG. 8 a ramp 42 with an end groove 44 are cut with the coarse cutter 34. The lines with arrows 46 indicate the movements of cutter 34 to make the ramp 42 and associated end groove 44. FIG. 9 shows the finishing tool 36 going over the same ramp 42 and associated end groove 44. When the finish cutting is completed in FIG. 9 two inspections are initiated as shown in FIGS. 10 and 11. In FIG. 10 the length of the cut 48 is determined as well as positioning the probe on the ramp 50 at the nose of the pin. FIG. 11 shows multiple readings with the probe 22 to check the slope of the ramp 42 and the dimensions of the associated end groove assembly 44 at 90 degrees from the first check. In some cases where the piece is out of tolerance at this point, it can still be corrected with further machining. Using the dimensions taken in the steps of FIGS. 10 and 11, this allows the CNC machine to do further machining to bring the piece into specifications without having to move the piece off the machine. This is because the probe 22 through its support system 24 is integrated into the machine so that the dimensions taken can be used as input to allow the processor to determine where and to what extent further machining is required before the thread is formed on the ramp 42.

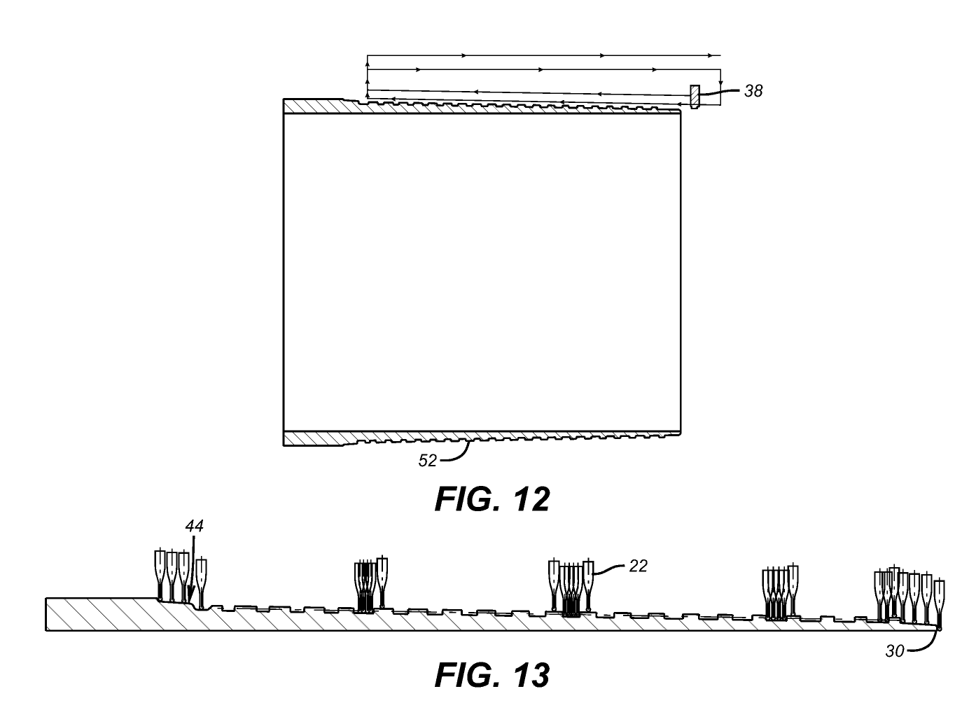

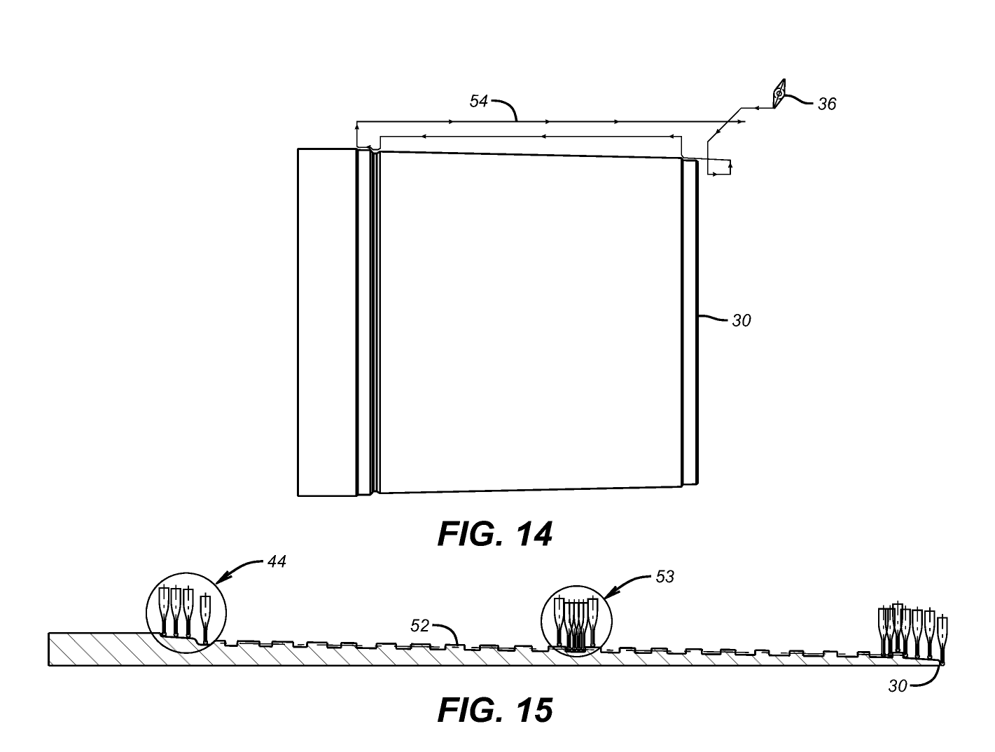

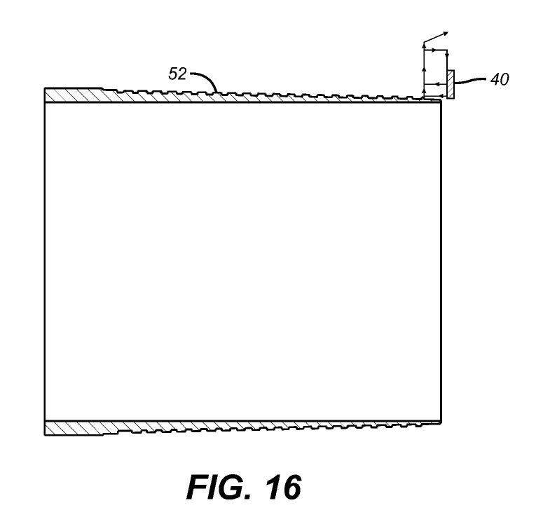

FIG. 12 shows the coarse thread cutter 38 cutting the thread form 52 out of what had been the ramp 42 while FIG. 13 shows the probe 22 examining the details of the thread form that has just been cut at select locations from end 30 to the groove assembly 44. FIG. 14 shows finish machining with the finish cutter 36 between the groove assembly 44 and near the nose end 30 as indicated by the motion lines 54. FIG. 15 shows the follow on inspection of the end area at 30 and the groove assembly 44 as well as the thread 52 in area 53. Finally the Higbee tool 40 dresses the leading end of the thread 52 as shown in FIG. 16.

While the discussion has focused on how to make the pin in a threaded connection, those skilled in the art will appreciate that making the box is the same process with the cutting going on in the interior of a tubular piece rather than on its exterior.

Those skilled in the art will appreciate that the integration of the probe into a CNC machine allows for accurate initial placement of a succession of cutters and the ability to check the accuracy of a cut after it is made so that if there is a need for corrective machining and that solution is still possible then the location and extent of the corrective machining is accurately determined without removal of the piece from the machine while also reducing the potential of measurement errors using the non-integrated instruments as in the past. Using the integrated probe the actual start location for each of the cutters is determined before any cutting takes place. With the orientation of the piece to be machined being determined sequential operations are undertaken to produce an initial taper into which a thread can be machined such as a pin thread on the outside of a tubular piece or a box thread on the inside of a tubular piece that will thread to the pin thread.

While threads on a tubular shape can be made using this method the applications are far broader than oilfield tubular threads. Other shapes can be machined using the integrated probe that not only orients the variety of cutters but also conducts inspections during the multistep procedure. These inspections permit corrective machining in some cases and ensure that the part dimensions are in specification during the machining process.

The above description is illustrative of the preferred embodiment and many modifications may be made by those skilled in the art without departing from the invention whose scope is to be determined from the literal and equivalent scope of the claims below.

We claim:

1. A method of machining a component on a CNC machine, comprising:
integrating a dimensional probe into control by a processor on the machine using at least one cutter on the machine to alter the component;
positioning said dimensional probe with at least one command from the processor to determine if the alteration to the part is within predetermined parameters.

2. The method of claim 1, comprising:
retaining the component to the machine while positioning said probe.

3. The method of claim 1, comprising:
alternating making an alteration with a cutter and taking a measurement with said probe.

4. The method of claim 1, comprising:
initially calibrating said probe against spaced gauge blocks supported from a chuck on said machine.

5. The method of claim 1, comprising:
using a tubular as said component.

6. The method of claim 5, comprising:
cutting a pin or box thread on said tubular.

7. The method of claim 1, comprising:
altering a component to within specification by using the same cutter that made the previous alteration, by removing additional material from the component as determined by the previous probe reading or readings.

8. The method of claim 1, comprising:
mounting the component in a chuck after calibrating said probe in perpendicular planes.

9. The method of claim 8, comprising:
locating the end of the component and an adjacent dimension in a perpendicular plane with the probe after mounting said component in said chuck.

10. The method of claim 9, comprising:
locating the end of the component and an adjacent dimension in a perpendicular plane with each cutter after mounting said component in said chuck.

11. The method of claim 1, comprising:
initially cutting a taper on the component.

12. The method of claim 11, comprising:
cutting a thread in said taper.

13. The method of claim 12, comprising:
using a tubular as the component.

14. The method of claim 13, comprising:
cutting said taper on the inside or the outside of the tubular.
